(19) United States
(12) Patent Application Publication
(10) Pub. No.: US 2025/0337183 A1
(43) Pub. Date: Oct. 30, 2025

(54) ELECTRICAL CONNECTOR WITH IMPROVED SIGNAL TRANSMISSION PERFORMANCE

(71) Applicant: Luxshare Precision Industry Company Limited, Shenzhen (CN)

(72) Inventors: James Patrick Young, Shenzhen (CN); Chien-Yu HSU, Shenzhen (CN); Chi-Wei LIN, Shenzhen (CN); Shu Hsien WEN, Shenzhen (CN)

(73) Assignee: Luxshare Precision Industry Company Limited, Shenzhen (CN)

(21) Appl. No.: 19/193,118

(22) Filed: Apr. 29, 2025

(30) Foreign Application Priority Data
Apr. 30, 2024 (CN) 202410538851.5

(51) Int. Cl. H01R 13/24; H01R 12/72; H01R 13/514; H01R 13/639

(52) U.S. Cl. CPC H01R 13/2407; H01R 12/721; H01R 13/514; H01R 13/639

(57) ABSTRACT

An electrical connector includes an installation body, a first conductive terminal and a slider. The installation body defines an insertion space. The first conductive terminal includes a first contact tail. The first contact tail includes a first contact area and a first extending stub. When the slider is located at a first position, the first contact tail does not protrude into the insertion space. When the slider is located at the second position, the first contact tail protrudes into the insertion space. The present disclosure shortens the useless residual section on the first conductive terminal and thus improves the performance when transmitting high-speed signals.

### CROSS-REFERENCE TO RELATED APPLICATION

This patent application claims priority of a Chinese Patent Application No. 202410538851.5, filed on Apr. 30, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

Electrical connectors in the related art generally include an insulating body and a plurality of conductive terminals fixed to the insulating body. The insulating body includes an insertion space for inserting a tongue plate. The plurality of conductive terminals are usually disposed on two sides of the insertion space. Each conductive terminal includes a fixing portion fixed to the insulating body, an elastic arm extending from the fixing portion, a contact portion connected to the elastic arm, and an end portion extending from the contact portion. The end portion is located at a free end of the conductive terminal. The contact portion includes a contact surface extending into the insertion space, and the contact surface is generally an arc-shaped surface. The end portion extends for a relatively long length along a centerline of the conductive terminal, and the purpose of this design is to form a bell mouth for guiding the insertion of the tongue plate. When the tongue plate is inserted into the insertion space, the tongue plate can be inserted smoothly under the guidance of the end portions, which reduces to a certain extent the risk of damaging the conductive terminals due to oblique insertion of the tongue plate. Of course, since the contact portions of the conductive terminals have already extended in the insertion space before the tongue plate is inserted into the insertion space, the contact portions are still susceptible to deformation or even failure due to contact with foreign objects.

More importantly, as the signal transmission requirements of electrical connectors continue to increase, the end portion in the related art will not contact a conductive pad on the tongue plate, so the end portion is actually a useless residual section, and it will affect the performance of the conductive terminals when transmitting high-speed signals.

Therefore, it is desirable to improve the electrical connectors in the related art.

### SUMMARY

An object of the present disclosure is to provide an electrical connector with improved conductive terminals to enhance the signal transmission performance.

In order to achieve the above object, the present disclosure adopts the following technical solution: an electrical connector defining an insertion space configured to receive a tongue plate, the electrical connector further including: an installation body, the installation body including a first side wall, a second side wall opposite to the first side wall, and an installation space located between the first side wall and the second side wall; the insertion space extending along a first direction; a plurality of first conductive terminals, the plurality of first conductive terminals being directly or indirectly fixed to the installation body; each first conductive terminal including a first elastic arm located on an inner side the first side wall and a first contact tail extending from the first elastic arm; the first contact tail being located at a free end of the first conductive terminal; the first contact tail including a first contact area configured to contact a first conductive pad of the tongue plate; a portion of the first contact tail extending from the first contact area along a centerline direction of the first conductive terminal being a first extending stub; and a slider, the slider being movable in the installation space along an insertion and extraction direction which is parallel to the first direction; the slider including an abutment portion located on one side of the plurality of first conductive terminals along a second direction which is perpendicular to the first direction; the abutment portion being configured to be pushed by the tongue plate to move the slider from a first position to a second position; when the slider is located at the first position, the first contact tail of the first conductive terminal does not protrude into the insertion space; when the slider is located at the second position, the first contact tail of the first conductive terminal protrudes into the insertion space, the first contact area of the first contact tail is brought into contact with the first conductive pad of the tongue plate; wherein a length of the first extending stub extending along the centerline direction of the first conductive terminal is L1, and the first conductive terminal is configured to transmit a signal with a frequency corresponding to a first wavelength f1, where 0≤L1≤¼*f1.

Compared with the prior art, the first contact tail of the first conductive terminal of the present disclosure is located at the free end of the first conductive terminal. The first contact tail includes the first contact area configured to contact the first conductive pad of the tongue plate, and a first extending stub extending from the first contact area along the centerline direction of the first conductive terminal. The length of the first extending stub extending along the centerline direction of the first conductive terminal is L1, and the first conductive terminal is configured to transmit a signal with a frequency corresponding to the first wavelength f1, where 0≤L1≤¼*f1. With this arrangement, the length of the first extending stub of the first conductive terminal of the electrical connector of the present disclosure is relatively short, which greatly shortens the useless residual section and improves the performance of the first conductive terminal when transmitting high-speed signals.

Besides, the electrical connector of the present disclosure includes a slider disposed in the installation space. The slider is configured to move back and forth in the installation space along the insertion and extraction direction. When the slider is located at the first position, the first contact tail of the first conductive terminal does not protrude into the insertion space. When the slider is located at the second position, the first contact tail of the first conductive terminal protrudes into the insertion space, so that the first contact area of the first contact tail is in contact with the first conductive pad of the tongue plate. With this arrangement, before the tongue plate is inserted into the insertion space, the first contact tail of the first conductive terminal does not protrude into the insertion space, which reduces the risk of damage to the first contact tail of the first conductive terminal by any foreign matter that may be inserted into the insertion space.

### BRIEF DESCRIPTION OF DRAWINGS

FIG. 1 is a schematic perspective view of an electrical connector and a tongue plate in accordance with a first embodiment of the present disclosure, where the tongue plate has not yet been inserted into the electrical connector;

FIG. 2 is a perspective view of FIG. 1 from another angle;

FIG. 3 is a partially exploded perspective view of the electrical connector in the first embodiment of the present disclosure;

FIG. 4 is a partially exploded perspective view of FIG. 3 from another angle;

FIG. 5 is a front view of FIG. 3;

FIG. 6 is a further exploded perspective view of FIG. 3;

FIG. 7 is a front view of FIG. 6;

FIG. 8 is an exploded perspective view of FIG. 6 from another angle;

FIG. 9 is a schematic cross-sectional view taken along line B-B in FIG. 1;

FIG. 10 is a schematic cross-sectional view when the tongue plate in FIG. 9 has just touched a slider, wherein the slider is located at a first position;

FIG. 11 is a schematic cross-sectional view of the tongue plate in FIG. 10 when it is further inserted, wherein the slider is located at a transition position;

FIG. 12 is a schematic cross-sectional view of the tongue plate in FIG. 11 when it is fully inserted, wherein the slider is located as a second position;

FIG. 13 is a partial enlarged view of a frame part D in FIG. 12;

FIG. 14 is a schematic perspective view of an electrical connector mated with a tongue plate in accordance with a second embodiment of the present disclosure, wherein the tongue plate is inserted into the electrical connector;

FIG. 15 is a perspective view of FIG. 14 from another angle;

FIG. 16 is a partially exploded perspective view of FIG. 14;

FIG. 17 is a partially exploded perspective view of FIG. 16 from another angle;

FIG. 18 is a partially exploded perspective view of the electrical connector shown in FIG. 16;

FIG. 19 is a partially exploded perspective view of FIG. 18 from another angle;

FIG. 20 is a further exploded perspective view of FIG. 18;

FIG. 21 is a front view of a terminal module mounted to a printed circuit board in the second embodiment of the present disclosure, in which the dotted lines indicate the state of the first conductive terminals and the second conductive terminals when the slider is in the second position;

FIG. 22 is a schematic cross-sectional view taken along line C-C in FIG. 14, wherein the slider is located at the first position;

FIG. 23 is a schematic cross-sectional view of the tongue plate in FIG. 22 when it is fully inserted, wherein the slider is located at the second position;

FIG. 24 is a schematic cross-sectional view of another embodiment when the tongue plate in FIG. 22 is fully inserted, wherein the slider is located at the second position;

FIG. 25 is a schematic cross-sectional view of an electrical connector in accordance with a third embodiment of the present disclosure when mated with the tongue plate, wherein the slider is located at the first position;

FIG. 26 is a schematic cross-sectional view of the tongue plate in FIG. 25 when it is further inserted, wherein the slider is located at the transition position;

FIG. 27 is a schematic cross-sectional view of the tongue plate in FIG. 26 when it is fully inserted, wherein the slider is located at the second position; and

FIG. 28 is a schematic cross-sectional view of an electrical connector and a tongue plate in accordance with a fourth embodiment of the present disclosure, where the tongue plate has not yet been inserted into the electrical connector.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

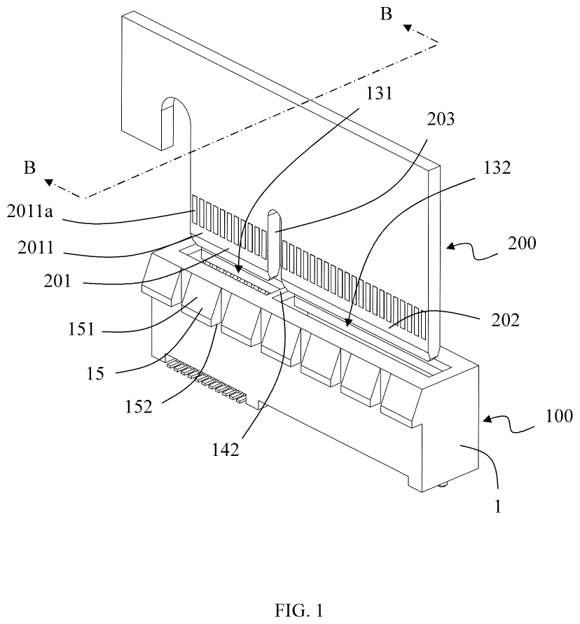

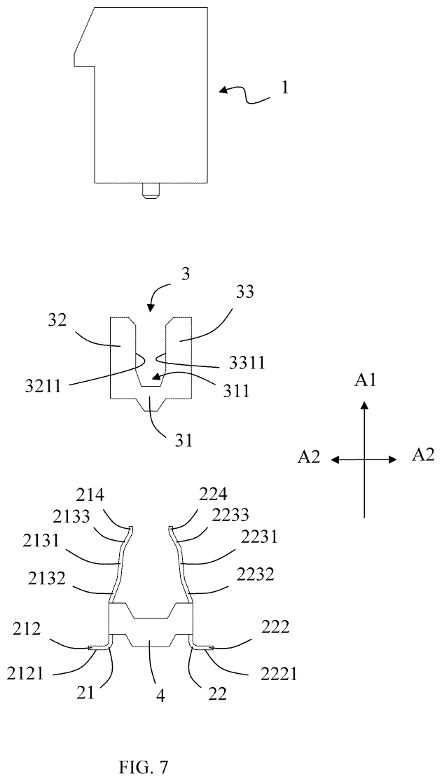

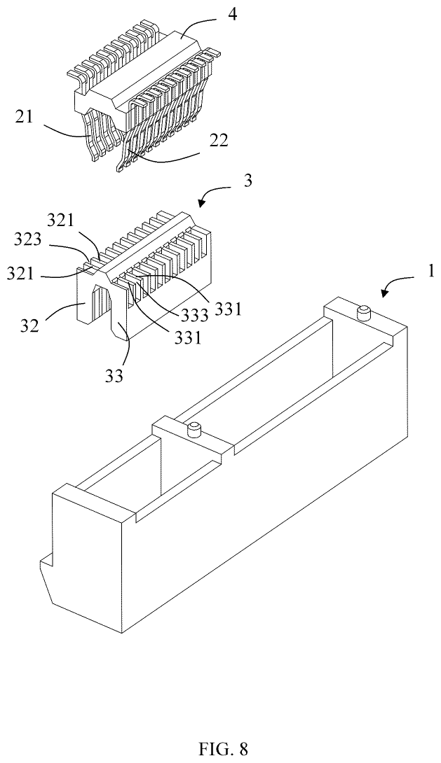

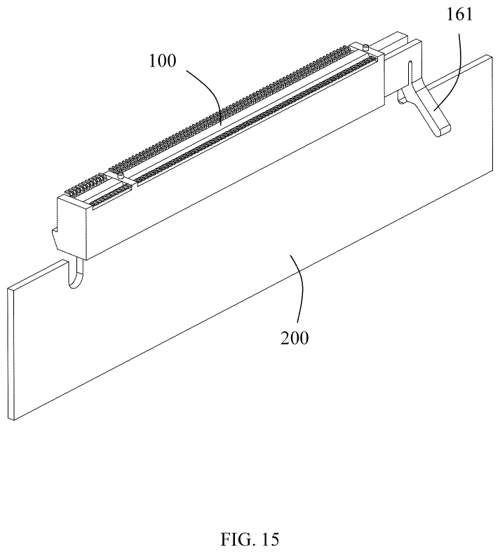

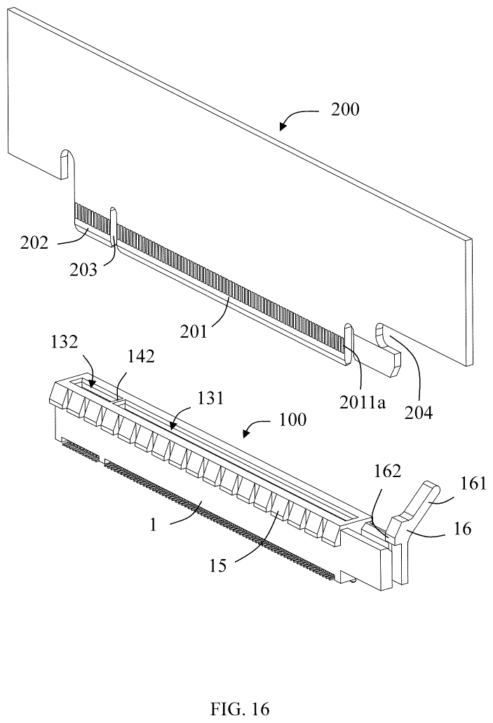

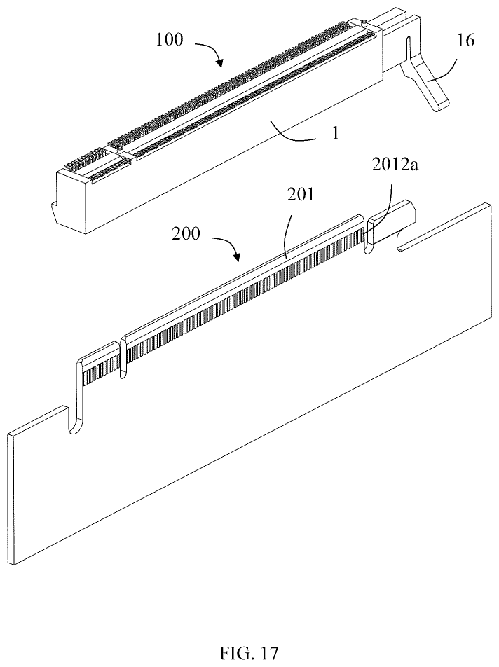

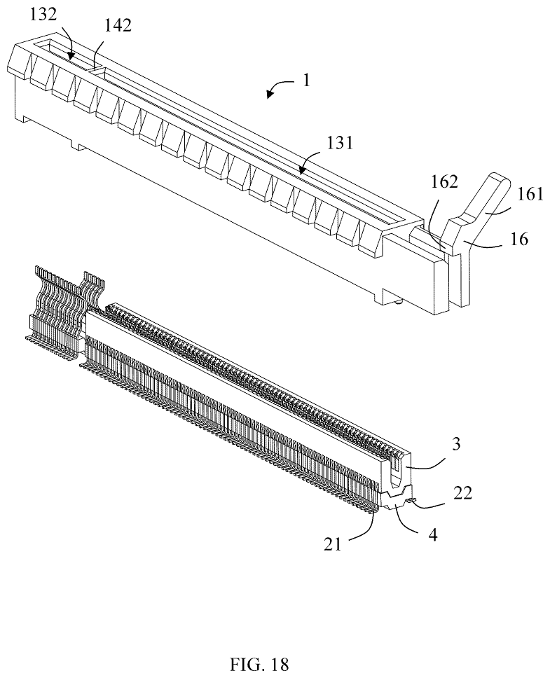

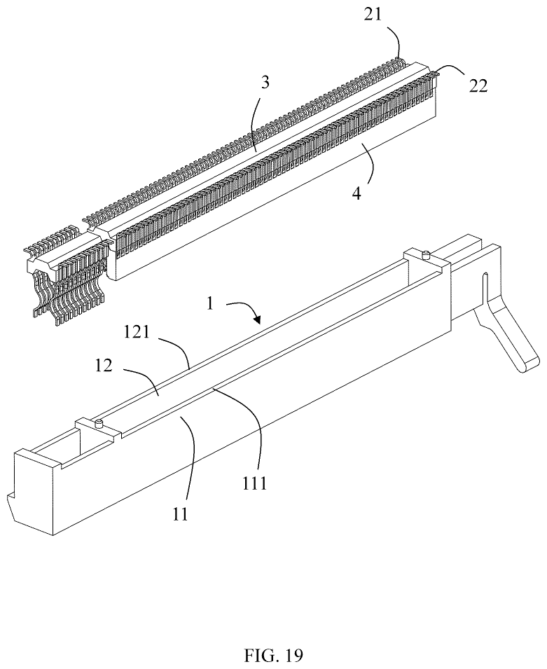

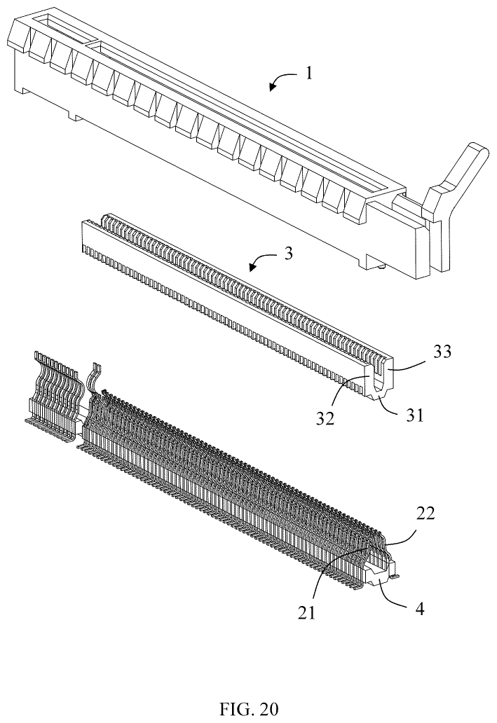

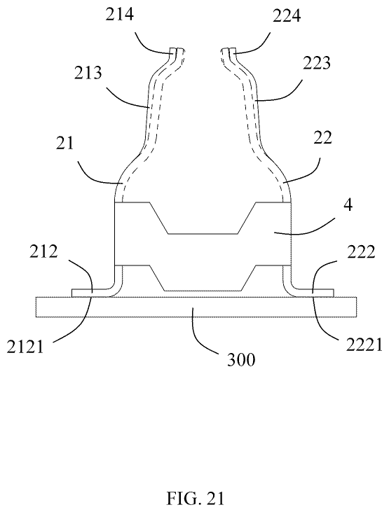

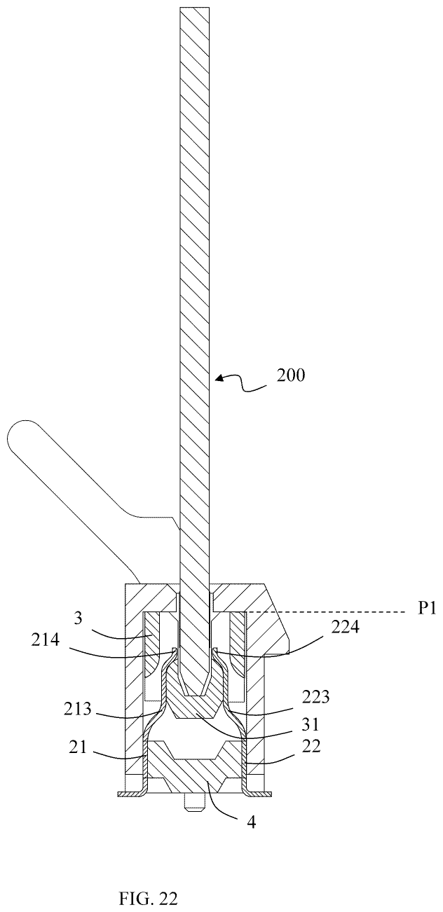

Referring to FIG. 1 to FIG. 28, the present disclosure discloses an electrical connector 100 for being mounted on a printed circuit board (PCB) 300 (shown in FIG. 21) and configured to receive a tongue plate 200. The tongue plate 200 may be a circuit board or a plate-shaped insertion portion with conductive pads on its surface. It is understandable to those skilled in the art that the tongue plate 200 can adopt various designs in the prior art, which is not limited in the present disclosure and will not be described again. In the illustrated embodiment of the present disclosure, the electrical connector 100 is a card edge connector.

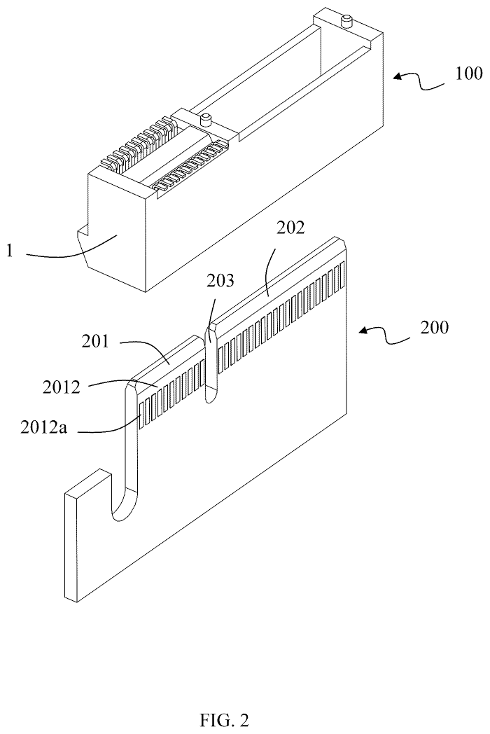

As shown in FIG. 1 and FIG. 2, the tongue plate 200 includes but is not limited to an electronic cards (for example, a memory card). The tongue plate 200 includes a first insertion portion 201, a second insertion portion 202, and a notch 203 located between the first insertion portion 201 and the second insertion portion 202. A width of the first insertion portion 201 is different from a width of the second insertion portion 202, so that it can prevent the tongue plate 200 from being inserted into the electrical connector 100 at an incorrect angle. Each of opposite surfaces of the first insertion portion 201 and the second insertion portion 202 is provided with a plurality of conductive pads which will be described in detail later. A detailed description will be given below only taking the plurality of conductive pads of the first insertion portion 201 as an example.

Referring to FIG. 1, FIG. 2 and FIG. 9 to FIG. 13, in the first embodiment of the present disclosure, the first insertion portion 201 includes a first surface 2011 (for example, a left side) and a second surface 2012 (for example, a right side) opposite to the first surface 2011. The plurality of conductive pads include a plurality of first conductive pads 2011a provided on the first surface 2011 and a plurality of second conductive pads 2012a provided on the second surface 2012. In the illustrated embodiment of the present disclosure, the plurality of first conductive pads 2011a are arranged in a row, and the plurality of second conductive pads 2012a are arranged in another row.

Referring to FIG. 1 to FIG. 13, in the first embodiment of the present disclosure, the electrical connector 100 includes an installation body 1, a plurality of first conductive terminals 21, a plurality of second conductive terminals 22 and a slider 3. The plurality of first conductive terminals 21 and the plurality of second conductive terminals 22 are directly or indirectly fixed to the installation body 1. The slider 3 is assembled to the installation body 1.

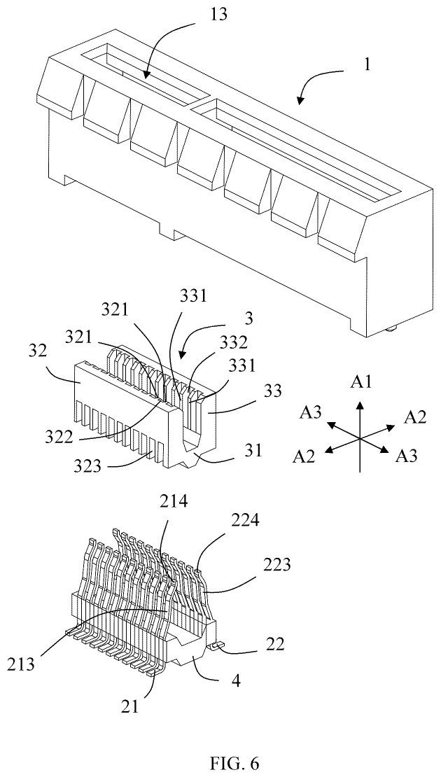

In an embodiment of the present disclosure, the installation body 1 is made of insulating material. The installation body 1 includes a first side wall 11 (for example, a left side wall), a second side wall 12 (for example, a right side wall) opposite to the first side wall 11, an installation space 10 located between the first side wall 11 and the second side wall 12, and an insertion space 13 communicating with the installation space 10. Referring to FIG. 6, in the illustrated embodiment of the present disclosure, the insertion space 13 extends through the installation body 1 along a first direction A1 (for example, a bottom-to-top direction) and is configured to at least partially receive the tongue plate 200. It is understandable to those skilled in the art that the insertion space 13 is a space that extends into the installation body 1 when the tongue plate 200 is inserted. The spatial range of the insertion space 13 may be limited by the installation body 1 and/or other components, and the specific situation may be determined according to the design structure and dimension of the electrical connector 100.

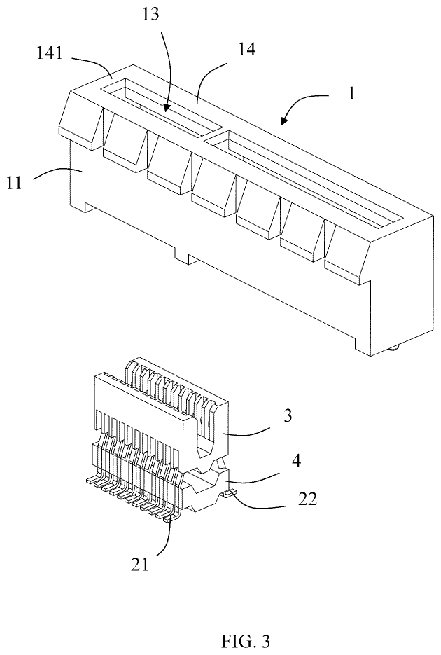

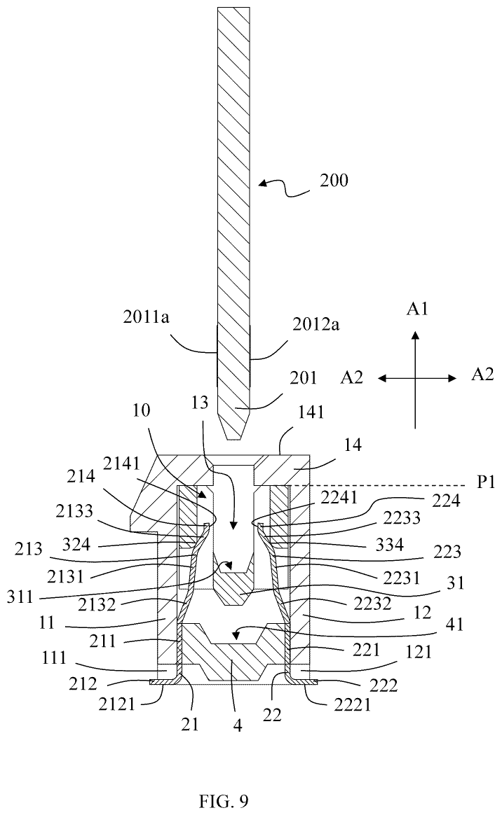

Referring to FIG. 3 and FIG. 9, in the first embodiment of the present disclosure, the installation body 1 further includes a mating portion 14. The first side wall 11 is connected to one side (for example, a left side) of the mating portion 14. The second side wall 12 is connected to another side (for example, a right side) of the mating portion 14. The mating portion 14 includes a mating surface 141 through which the insertion space 13 extends along the first direction A1. The mating portion 14 is configured to abut against the slider 3 to limit a position of the slider 3. For example, the mating portion 14 is configured to limit the slider 3 to the first position P1, that is, an initial position.

Referring to FIG. 1 and FIG. 2, in the illustrated embodiment of the present disclosure, the mating portion 14 includes a partition key 142 which divides the insertion space 13 into a first insertion space 131 located on one side of the partition key 142 and a second insertion space 132 located on the other side of the partition key 142. In the illustrated embodiment of the present disclosure, a width of the first insertion space 131 is different from a width of the second insertion space 132. The first insertion space 131 is used to receive the first insertion portion 201. The second insertion space 132 is used to receive the second insertion portion 202. The separation key 142 is used to be received in the notch 203. It is understandable to those skilled in the art that by designing the width of the first insertion space 131 and the width of the second insertion space 132 to be different, reverse insertion of the tongue plate 200 can be avoided. It is also understandable to those skilled in the art that the first insertion space 131 and the second insertion space 132 can be selected to match different types of conductive terminals according to required electrical requirements. The drawings of the present disclosure only take the first insertion space 131 as an example, but the present disclosure is not limited thereto.

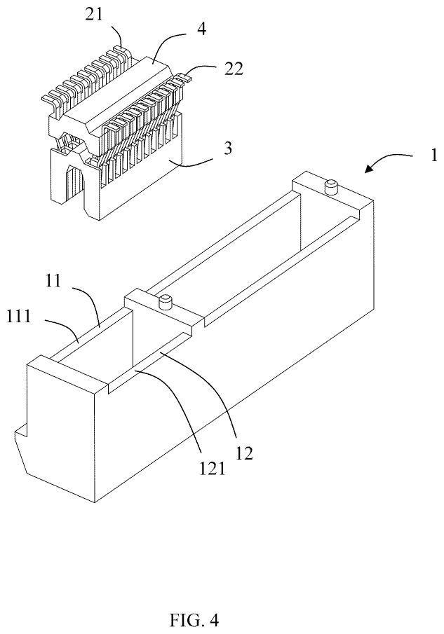

Referring to FIG. 4 and FIG. 9, in the first embodiment of the present disclosure, the first side wall 11 further includes a first relief groove 111 at a bottom thereof, and the second side wall 12 further includes a second relief groove 121 at a bottom thereof.

Besides, the installation body 1 further includes a locking protrusion 15 protruding outwardly from the first side wall 11. In the illustrated embodiment of the disclosure, the locking protrusion 15 is integrally formed with the first side wall 11. The locking protrusion 15 is provided with an inclined surface 151 on the outside and a locking surface 152 at the bottom. The locking surface 152 is used for a locking spring sheet (not shown) to lock, so that the tongue plate 200 is fixed to the electrical connector 100 through the locking spring sheet.

Referring to FIG. 3 to FIG. 9, in the first embodiment of the present disclosure, the electrical connector 100 further includes an insulating block 4 fixed on the plurality of first conductive terminals 21 and fixed on the plurality of second conductive terminals 22. In an embodiment of the present disclosure, the plurality of first conductive terminals 21 and the plurality of second conductive terminals 22 are insert-molded with the insulating block 4. Of course, in other embodiments, the plurality of first conductive terminals 21 and the plurality of second conductive terminals 22 can also be fixed to the insulating block 4 by assembling. It is understandable to those skilled in the art that in other embodiments of the present disclosure, the insulating block 4 may not be provided. At this time, the plurality of first conductive terminals 21 and the plurality of second conductive terminals 22 are directly or indirectly fixed to the installation body 1, by assembling for example.

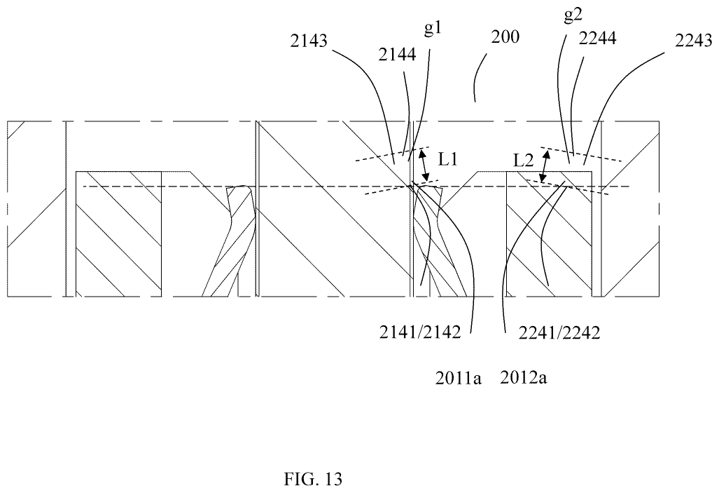

Referring to FIG. 9 and FIG. 13, in the first embodiment of the present disclosure, the insulating block 4 includes a limiting groove 41. The limiting groove 41 is used to mate with the slider 3 to limit the slider 3 (for example, to limit the slider 3 at the second position P2, that is, a fully inserted position).

In the first embodiment of the present disclosure, each first conductive terminal 21 includes a first fixing portion 211 fixed to the insulating block 4, a first mounting portion 212 extending from one end of the first fixing portion 211, a first elastic arm 213 extending from another end of the first fixing portion 211, and a first contact tail 214 extending from the first elastic arm 213. In the illustrated embodiment of the present disclosure, the first elastic arm 213 is located on an inner side of the first side wall 11. In the illustrated embodiment of the present disclosure, a length of the first contact tail 214 is relatively short so as to minimize useless residual sections. The first contact tail 214 is located at a free end of the first conductive terminal 21.

As shown in FIG. 13, in the first embodiment of the disclosure, the first contact tail 214 includes a first contact area 2142 configured to contact the first conductive pad 2011a of the tongue plate 200 and a first extending stub 2143 extending from the first contact area 2142 along a centerline direction of the first conductive terminal 21. When the tongue plate 200 is completely inserted into the insertion space 13, the first extending stub 2143 protrudes outwardly with respect to the tongue plate 200 and forms a first gap g1 with the tongue plate 200. The first extending stub 2143 is a residual section that does not have electrical contact with the tongue plate 200. The purpose of providing the first extending stub 2143 in the present disclosure is to reduce excessive wiping on the first conductive pad 2011a by the first contact tail 214, thereby avoiding damage to the first conductive sheet 2011a. In the first embodiment illustrated in the present disclosure, the first extending stub 2143 is provided with a first corner 2144 adjacent to the tongue plate 200. Preferably, the first corner 2144 is rounded to further reduce excessive wiping on the first conductive sheet 2011a, thereby avoiding damage to the first conductive sheet 2011a. In another embodiment of the present disclosure, the first contact tail 214 is not extended, that is, it does not have the first extending stub 2143. At this time, the first contact tail 214 is provided with a rounded first corner 2144 to prevent excessive wiping.

It is understandable to those skilled in the art that when an electrical connector supports high-speed data transmission, it is necessary to ensure the transmission quality of high-frequency signals. The transmission frequency of each signal has its corresponding wavelength f, where f=V/λ, V is a wave speed, f is a frequency, and λ is a wavelength. Generally, the wave speed V transmitted in the air is close to the speed of light, that is, V=3*10⁸ m/s.

A length of the first extending stub 2143 extending along the centerline direction of the first conductive terminal 21 is L1, and the first conductive terminal 21 is configured to transmit a signal with a frequency corresponding to a first wavelength f1, where 0≤L1≤¼*f1. That is, the length L1 extending along the centerline direction of the first conductive terminal 21 is less than a quarter of the first wavelength f1. For example, according to the conversion, the wavelength of 30 GHz is approximately 10 mm, and ¼ wavelength thereof is 2.5 mm; the wavelength of 40 GHz is approximately 7.5 mm, and ¼ wavelength thereof is 1.87 mm; the wavelength of 50 GHz is approximately 6 mm, and ¼ wavelength thereof is 1.5 mm. When L1 is zero, that is, when there is no first extending stub 2143, the impact of the residual section on the electrical connector 100 is minimal. At the same time, in order to reduce excessive wiping on the first conductive sheet 2011a, preferably, the first contact tail 214 is provided with the rounded first corner 2144. When L1>0, that is, when the first extending stub 2143 is provided, although excessive wiping can be reduced, the length of the first extending stub 2143 needs to be controlled to reduce the impact of the residual section on the electrical connector 100. In an embodiment of the present disclosure, the shortest length of L1 is approximately ¼˜⅓ of the thickness of the conductive terminal. That is, if the terminal thickness is 0.15 mm, the shortest length of L1 is approximately 0.04 mm. In an embodiment of the present disclosure, 50 GHz is used as the highest target frequency, where 0.04 mm≤L1≤1.5 mm.

Referring to FIG. 9 and FIG. 21, in the illustrated embodiment of the present disclosure, the first mounting portion 212 is perpendicular to the first fixing portion 211. The first mounting portion 212 is bent outwardly from the first fixing portion 211. The first mounting portion 212 includes a first mounting surface 2121 which is configured to be mounted on the printed circuit board 300 to be electrically connected to the printed circuit board 300.

The first elastic arm 213 of each first conductive terminal 21 includes a first extension portion 2131, a first connecting portion 2132 connecting the first extension portion 2131 and the first fixing portion 211, and a second connecting portion 2133 connecting the first extension portion 2131 and the first contact tail 214. The first fixing portion 211, the first connecting portion 2132, the first extension portion 2131, the second connecting portion 2133 and the first contact tail 214 approach the insertion space 13 in sequence along a second direction A2-A2 (for example, a left-right direction), and are arranged in sequence along the first direction A1. The first direction A1 and the second direction A2-A2 are perpendicular to each other.

Similarly, in the illustrated embodiment of the present disclosure, each second conductive terminal 22 includes a second fixing portion 221 fixed to the insulating block 4, a second mounting portion 222 extending from one end of the second fixing portion 221, a second elastic arm 223 extending from another end of the second fixing portion 221, and a second contact tail 224 extending from the second elastic arm 223. In the illustrated embodiment of the present disclosure, the second elastic arm 223 is located on an inner side of the second side wall 12. In the illustrated embodiment of the present disclosure, a length of the second contact tail 224 is relatively short to minimize the useless residual section. The second contact tail 224 is located at a free end of the second conductive terminal 22.

Referring to FIG. 13, in the first embodiment of the present disclosure, the second contact tail 224 includes a second contact area 2242 configured to contact the second conductive pad 2012a of the tongue plate 200 and a second extending stub 2243 extending from the second contact area 2242 along a centerline direction of the second conductive terminal 22. When the tongue plate 200 is completely inserted into the insertion space 13, the second extending stub 2243 protrudes outwardly with respect to the tongue plate 200 and forms a second gap g2 with the tongue plate 200. The second extending stub 2243 is a residual section that does not have electrical contact with the tongue plate 200. The purpose of providing the second extending stub 2243 in the present disclosure is to reduce excessive wiping on the second conductive sheet 2012a by the second contact tail 224, thereby avoiding damage to the second conductive sheet 2012a. In the first embodiment illustrated in the present disclosure, the second extending stub 2243 is provided with a second corner 2244 adjacent to the tongue plate 200. Preferably, the second corner 2244 is rounded to further reduce excessive wiping on the second conductive sheet 2012a, thereby avoiding damage to the second conductive sheet 2012a. In another embodiment of the present disclosure, the second contact tail 224 is not extended, that is, it does not have the second extending stub 2243. At this time, the second contact tail 224 is provided with a rounded second corner 2244 to prevent excessive wiping.

A length of the second extending stub 2243 extending along the centerline direction of the second conductive terminal 22 is L2, and the second conductive terminal 22 is configured to transmit a signal with a frequency corresponding to the second wavelength f2, where 0≤L2≤¼*f2. That is, the length L2 of the second extending stub 2243 extending along the centerline direction of the second conductive terminal 22 is less than one quarter of the second wavelength f2. For example, according to the conversion, the wavelength of 30 GHz is approximately 10 mm, and ¼ wavelength thereof is 2.5 mm; the wavelength of 40 GHz is approximately 7.5 mm, and ¼ wavelength thereof is 1.87 mm; the wavelength of 50 GHz is approximately 6 mm, and ¼ wavelength thereof is 1.5 mm. When L2 is zero, that is, when there is no second extending stub 2243, the impact of the residual section on the electrical connector 100 is minimal. At the same time, in order to reduce excessive wiping on the second conductive sheet 2012a, preferably, the second contact tail 224 is provided with a rounded second corner 2244. When L2>0, that is, with the second extending stub 2243, although excessive wiping can be reduced, the length of the second extending stub 2243 needs to be controlled to reduce the impact of the residual section on the electrical connector 100. In an embodiment of the present disclosure, the shortest length of L2 is approximately ¼˜⅓ of the thickness of the conductive terminal. That is, if the terminal thickness is 0.15 mm, the shortest length of L2 is approximately 0.04 mm. In an embodiment of the present disclosure, 50 GHz is used as the highest target frequency, where 0.04 mm≤L2≤1.5 mm.

It is understandable to those skilled in the art that although the first contact tail 214 and the second contact tail 224 are respectively provided with the first extending stub 2143 and the second extending stub 2243 as residual sections, the length of the first extending stub 2143 itself and the length of the second extending stub 2243 itself are already very short, so that they will not have too many adverse effects on high-speed signal transmission. Of course, ideally, without considering the wiping effect on the first conductive pad 2011a and the second conductive pad 2012a of the tongue plate 200, when the length of the first extending stub 2143 and the length of the second extending stub 2243 are zero, that is, without the first extending stub 2143 and the second extending stub 2243, the high-speed performance of the first conductive terminal 21 and the second conductive terminal 22 is the best. In any case, those skilled in the art can understand that the first extending stub 2143 and the second extending stub 2243 of the present disclosure are significantly different from those provided at the free end of the conductive terminal in the prior art for the purpose of guiding the insertion of the tongue plate.

Referring to FIG. 9 and FIG. 21, in the illustrated embodiment of the present disclosure, the second mounting portion 222 is perpendicular to the second fixing portion 221. The second mounting portion 222 is bent outwardly from the second fixing portion 221. The first mounting portion 212 and the second mounting portion 222 extend in opposite directions. The second mounting portion 222 includes a second mounting surface 2221. The second mounting surface 2221 is configured to be mounted on the printed circuit board 300 to be electrically connected to the printed circuit board 300. In one embodiment of the present disclosure, the first mounting surface 2121 and the second mounting surface 2221 are fixed to the printed circuit board 300 by surface soldering technologies (SMT). It is understandable to those skilled in the art that in other embodiments of the present disclosure, the first mounting portion 212 and the second mounting portion 222 may also be electrically connected to corresponding components in other ways. For example, the first mounting portion 212 and the second mounting portion 222 may be electrically connected to the printed circuit board 300 through press-fit, through hole, etc.; or the first mounting portion 212 and the second mounting portion 222 are connected to cables, which will not be described again in the present disclosure.

The second elastic arm 223 of each second conductive terminal 22 includes a second extension portion 2231, a third connecting portion 2232 connecting the second extension portion 2231 and the second fixing portion 221, and a fourth connecting portion 2233 connecting the second extension portion 2231 and the second contact tail 224. The second fixing portion 221, the third connecting portion 2232, the second extension portion 2231, the fourth connecting portion 2233 and the second contact tail 224 approach the insertion space 13 in sequence along the second direction A2-A2, and are arranged in sequence along the first direction A1.

In the illustrated embodiment of the present disclosure, the first conductive terminals 21 and the second conductive terminals 22 are symmetrically arranged on two sides (for example, left and right sides) of the insertion space 13. In the illustrated embodiment of the present disclosure, the outer side of the first fixing portion 211 is pressed against and fixed by the inner wall surface of the first side wall 11. The outer side of the second fixing portion 221 is pressed against and fixed by the inner wall surface of the second side wall 12.

The slider 3 is disposed in the installation space 10, and is movable back and forth in the installation space 10 along an insertion and extraction direction (for example, a top-bottom direction) of the tongue plate 200. The insertion and extraction direction is parallel to the first direction A1. In an embodiment of the present disclosure, the slider 3 is made of insulating material.

Referring to FIG. 9 to FIG. 1, the slider 3 includes an abutment portion 31 located between the plurality of first conductive terminals 21 and the plurality of second conductive terminals 22 along the second direction A2-A2. The abutment portion 31 is configured to be pushed by the tongue plate 200 to move the slider 3 from a first position P1 to a second position P2.

When the slider 3 is located at the first position P1, the first contact tail 214 of the first conductive terminal 21 and the second contact tail 224 of the second conductive terminal 22 do not protrude into the insertion space 13. Therefore, the first contact tail 214 of the first conductive terminal 21 and the second contact tail 224 of the second conductive terminal 22 can be better protected.

When the slider 3 is located at the second position P2, the first elastic arm 213 of the first conductive terminal 21 and the second elastic arm 223 of the second conductive terminal 22 move inwardly. The first contact tail 214 of the first conductive terminal 21 and the second contact tail 224 of the second conductive terminal 22 protrude into the insertion space 13. The first contact area 2142 of the first contact tail 214 and the second contact area 2242 of the second contact tail 224 are in contact with the first conductive pad 2011a and the second conductive pad 2012a of the tongue plate 200, respectively.

Specifically, as shown in FIG. 9, in a first embodiment of the present disclosure, when the slider 3 is located at the first position P1, the slider 3 abuts against the first elastic arm 213 of the first conductive terminal 21 outwardly and abuts against the second elastic arm 223 of the second conductive terminal 22 outwardly, so as to prevent the first contact tail 214 of the first conductive terminal 21 and the second contact tail 224 of the second conductive terminal 22 from protruding into the insertion space 13.

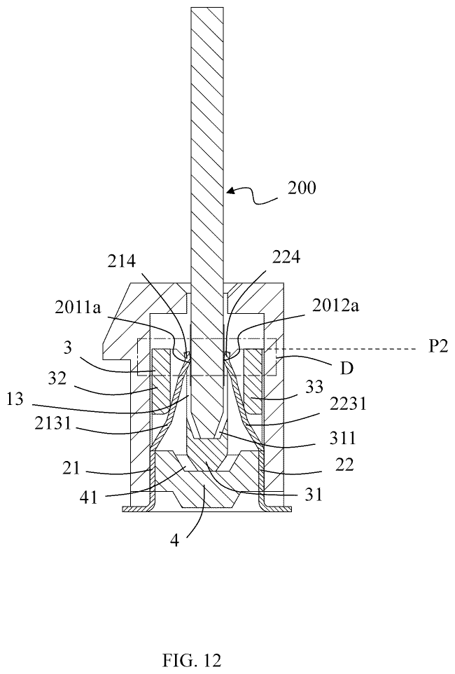

Referring to FIG. 12, when the slider 3 is located at the second position P2, the pressing force of the slider 3 on the first elastic arm 213 of the first conductive terminal 21 and the pressing force of the slider 3 on the second elastic arm 223 of the second conductive terminal 22 are reduced. The first elastic arm 213 of the first conductive terminal 21 and the second elastic arm 223 of the second conductive terminal 22 move inwardly, causing the first contact tail 214 of the first conductive terminal 21 and the second contact tail 224 of the second conductive terminal 22 protrude into the insertion space 13, and are in contact with the first conductive pad 2011a and the second conductive pad 2012a of the tongue plate 200, respectively.

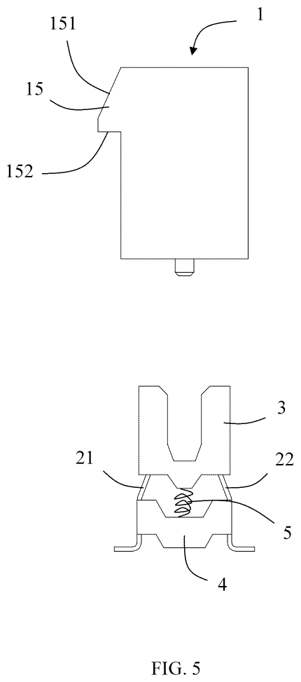

In the illustrated embodiment of the present disclosure, the electrical connector 100 further includes a resilient element 5. The resilient element 5 exerts a restoring force on the slider 3 to return the slider 3 from the second position P2 to the first position P1 when the tongue plate 200 is pulled out. Referring to FIG. 5, in one embodiment of the present disclosure, the resilient element 5 is disposed between the insulating block 4 and the slider 3. The resilient element 5 can be a spring, an elastic sheet, or other element capable of providing restoring force. It is understandable to those skilled in the art that the resilient element 5 can be flexibly selected according to design needs, and will not be described in detail in the present disclosure.

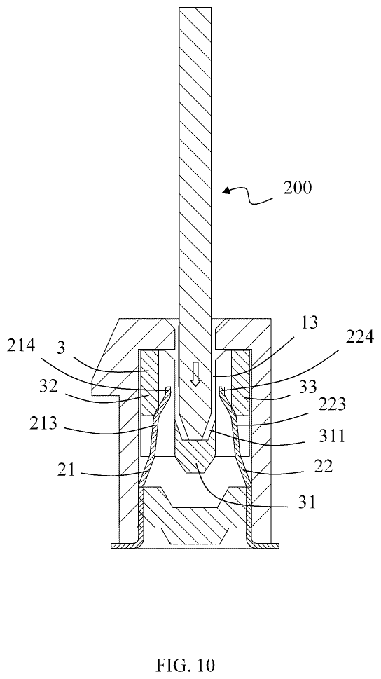

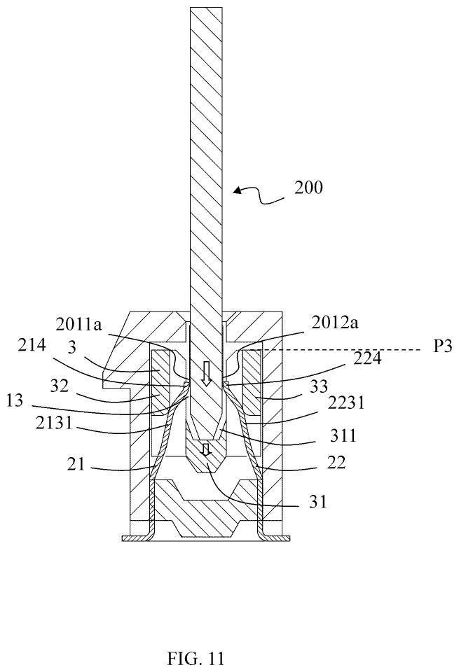

As shown in FIG. 10 and FIG. 11, the slider 3 also passes through a transition position P3 when moving from the first position P1 to the second position P2. The transition position P3 is located between the first position P1 and the second position P2. When the slider 3 is located at the transition position P3, the first contact tail 214 of the first conductive terminal 21 and the second contact tail 224 of the second conductive terminal 22 protrude into the insertion space 13, and are in contact with the first conductive pad 2011a and the second conductive pad 2012a of the tongue plate 200, respectively.

Referring to FIG. 11 and FIG. 12, when the slider 3 moves from the transition position P3 to the second position P2, the first contact tail 214 of the first conductive terminal 21 and the second contact tail 224 of the second conductive terminal 22 scrap on the first conductive pad 2011a and the second conductive pad 2012a of the tongue plate 200, respectively. This wiping facilitates the removal of impurities (such as dust), thereby improving contact reliability. Of course, it is understandable to those skilled in the art that such wiping should be limited to a certain extent to avoid damage to the first conductive pad 2011a and the second conductive pad 2012a of the tongue plate 200. In an embodiment of the present disclosure, when the slider 3 moves from the first position P1 to the second position P2 or to the transition position P3, the distance between the contact positions of the first contact tail 214 of the first conductive terminal 21 and the first conductive sheet 2011a is within a range of 0.5 mm to 0.8 mm; and the distance between the contact positions of the second contact tail 224 of the second conductive terminal 22 and the second conductive sheet 2012a is within a range of 0.5 mm to 0.8 mm. In other words, in one embodiment of the present disclosure, the wiping distance between the first contact tail 214 of the first conductive terminal 21 and the first conductive sheet 2011a is within a range of 0.5 mm to 0.8 mm; and the wiping distance between the second contact tail 224 of the second conductive terminal 22 and the second conductive sheet 2012a is within a range of 0.5 mm to 0.8 mm. Of course, it is understandable to those skilled in the art that the wiping distance depends on product size, tolerance, wiping effect and other requirements, which is not limited by the present disclosure.

The first contact tail 214 includes a first contact surface 2141. The second contact tail 224 includes a second contact surface 2241. The first contact surface 2141 and the second contact surface 2241 are in contact with the first conductive pad 2011a and the second conductive pad 2012a of the tongue plate 200, respectively. In the illustrated embodiment of the present disclosure, the first contact surface 2141 corresponds to the first contact area 2142; and the second contact surface 2241 corresponds to the second contact area 2242.

In an embodiment of the present disclosure, the first contact surface 2141 is a flat surface, and the second contact surface 2241 is a flat surface. When the tongue plate 200 is completely inserted into the insertion space 13, the slider 3 is located at the second position P2, the first contact surface 2141 is completely in contact with the first conductive sheet 2011a, and the second contact surface 2241 is completely in contact with the second conductive sheet 2012a.

It is understandable to those skilled in the art that in other embodiments of the present disclosure, the first contact surface 2141 may also be a slightly curved arc surface, and the second contact surface 2241 may also be a slightly curved arc surface. When the tongue plate 200 is completely inserted into the insertion space 13, the slider 3 is located at the second position P2, the first contact surface 2141 is completely in contact with the first conductive sheet 2011a, and the second contact surface 2241 is completely in contact with the second conductive sheet 2012a.

Referring to FIG. 9, in the illustrated embodiment of the present disclosure, the abutment portion 31 defines a positioning groove 311 exposed in the insertion space 13. The positioning groove 311 is configured to mate with the first insertion portion 201 of the tongue plate 200.

Referring to FIG. 6 to FIG. 9, in the illustrated embodiment of the present disclosure, the slider 3 includes a first wall portion 32 connected to one side of the abutment portion 31 and a second wall portion 33 connected to the other side of the abutment portion 31. The first wall portion 32 is located on an inner side of the first side wall 11. The second wall portion 33 is located on an inner side of the second side wall 12. The first wall portion 32 is provided with a plurality of first partition ribs 321 and a plurality of first grooves 322 spaced apart along a third direction A3-A3 (for example, a front-rear direction). Each first groove 322 is located between two adjacent first partition ribs 321. The second wall portion 33 is provided with a plurality of second partition ribs 331 and a plurality of second grooves 332 spaced apart along the third direction A3-A3. Each second groove 332 is located between two adjacent second partition ribs 331.

After assembly, the first elastic arm 213 of the first conductive terminal 21 is located in a corresponding first groove 322; and the second elastic arm 223 of the second conductive terminal 22 is located in a corresponding second groove 332.

Each first partition rib 321 includes a first inner wall surface 3211 exposed in the insertion space 13. These first inner wall surfaces 3211 of the plurality of first partition ribs 321 are located on a same plane. Each second partition rib 331 includes a second inner wall surface 3311 exposed in the insertion space 13. These second inner wall surfaces 3311 of the plurality of second partition ribs 331 are located on a same plane. When the slider 3 is located at the first position P1, the first contact tail 214 does not protrude beyond the first inner wall surfaces 3211, and the second contact tail 224 does not protrude beyond the second inner wall surfaces 3311. In other words, the first contact tail 214 and the second contact tail 224 are hidden inside the first partition rib 321 and the second partition rib 331, respectively, thereby reducing the risk of being damaged by foreign objects.

When the slider 3 is located at the second position P2, the first contact tail 214 protrudes beyond the first inner wall surfaces 3211 to protrude into the insertion space 13, and the second contact tail 224 protrudes beyond the second inner wall surfaces 3311 to protrude into the insertion space 13.

In the illustrated embodiment of the present disclosure, the first wall portion 32 defines a plurality of first openings 323. The first openings 323 and the first grooves 322 are arranged in a one-to-one correspondence manner. The first elastic arm 213 of the first conductive terminal 21 passes through a corresponding first opening 323 to extend into the corresponding first groove 322. Similarly, the second wall portion 33 defines a plurality of second openings 333. The second openings 333 and the second grooves 332 are arranged in a one-to-one correspondence manner. The second elastic arm 223 of the second conductive terminal 22 passes through a corresponding second opening 333 to extend into the corresponding second groove 332.

As shown in FIG. 9, in the first embodiment of the present disclosure, the first wall portion 32 is provided with a plurality of first force applying portions 324 of which each is located in the corresponding first groove 322. The second wall portion 33 is provided with a plurality of second force applying portions 334 of which each is located in the corresponding second groove 332. When the slider 3 is located at the second position P2, the first force applying portion 324 and the second force applying portion 334 press against the first elastic arm 213 of the first conductive terminal 21 an the second elastic arm 223 of the second conductive terminal 22, respectively. As a result, the first contact tail 214 of the first conductive terminal 21 and the second contact tail 224 of the second conductive terminal 22 protrude into the insertion space 13, and are in contact with the first conductive pad 2011a and the second conductive pad 2012a of the tongue plate 200, respectively.

In the illustrated embodiment of the present disclosure, the first force applying portion 324 is a first corner of the first wall portion 32 that is exposed in the corresponding first opening 323; and the second force applying portion 334 is a second corner of the second wall portion 33 that is exposed in the corresponding second opening 333.

In an embodiment of the present disclosure, the first extension portion 2131 extends obliquely and is configured to be abutted against by the first corner of the slider 3 when the slider 3 is located at the second position P2. The second extension portion 2231 extends obliquely and is configured to be abutted against by the second corner of the slider 3 when the slider 3 is located at the second position P2. In the illustrated embodiment of the present disclosure, the first corner is arc-shaped, and the second corner is arc-shaped, in order to reduce damage to the first elastic arm 213 of the first conductive terminal 21 and the second elastic arm 223 of the second conductive terminal 22.

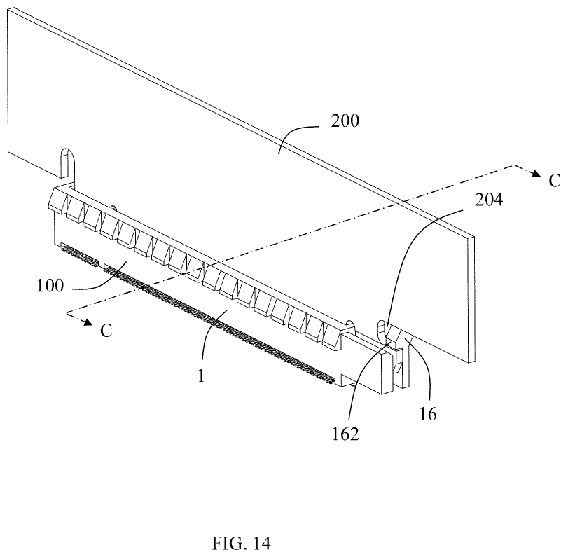

Referring to FIG. 14 to FIG. 23, in the second embodiment of the electrical connector 100 of the present disclosure, the electrical connector 100 is substantially the same as the electrical connector 100 in the first embodiment. The same or corresponding technical features may be referred to the description in the first embodiment, and will not be described again in the present disclosure. The following describes the main differences between the electrical connector 100 in the second embodiment and the electrical connector 100 in the first embodiment.

In the second embodiment of the electrical connector 100 of the present disclosure, the installation body 1 further includes a latch arm 16 connected to the second side wall 12. In the second embodiment illustrated in the present disclosure, the latch arm 16 and the second side wall 12 are integrally formed. The latch arm 16 includes a force applying portion 161 and a latch protrusion 162.

Correspondingly, the tongue plate 200 further includes a locking hole 204. When the tongue plate 200 is fully inserted into the insertion space 13, the locking protrusion 162 is locked in the locking hole 204 to prevent the tongue plate 200 from being separated from the electrical connector 100. When unlocking is required, an outward force is applied to the force applying portion 161 to cause the locking protrusion 162 to separate from the locking hole 204. Then, by applying a force in the pulling direction of the tongue plate 200, the tongue plate 200 can be separated from the electrical connector 100. Of course, it is understandable to those skilled in the art that the tongue plate 200 and the electrical connector 100 can be fixed in various ways and are not limited to the forms disclosed in the specific embodiments of the present disclosure. For example, the tongue plate 200 and the electrical connector 100 can be fixed together through common fixing methods such as external frames and screws.

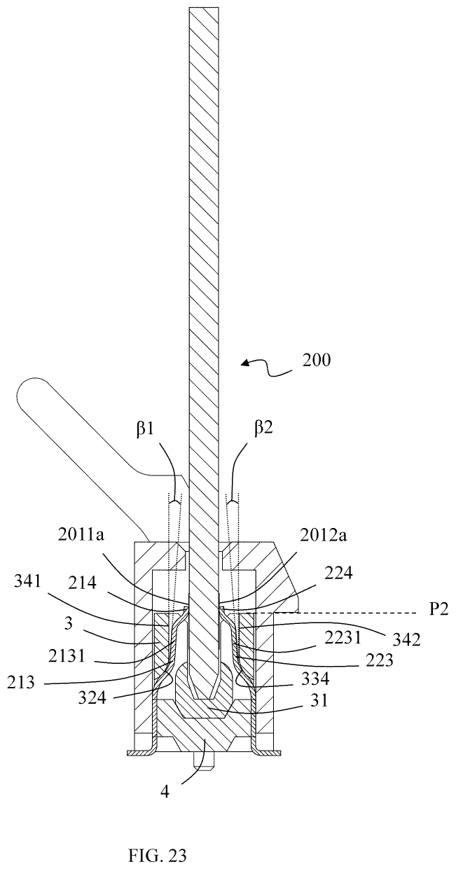

As shown in FIG. 23, the slider 3 includes a first inner wall surface 341 and a second inner wall surface 342. The first inner wall surface 341 is provided on an inner side of the first wall portion 32. The second inner wall surface 342 is provided on an inner side of the second wall portion 33. The first elastic arm 213 includes a first extension portion 2131 corresponding to the first inner wall surface 341. The second elastic arm 223 includes a second extension portion 2231 corresponding to the second inner wall surface 342. The first extension portion 2131 is located on an inner side of the first inner wall surface 341. The second extension portion 2231 is located on an inner side of the second inner wall surface 342. When the slider 3 is located at the second position P2, the first extension portion 2131 and the first inner wall surface 341 form a first included angle β1; and the second extension portion 2231 and the second inner wall surface 342 form a second included angle β2. In an embodiment of the present disclosure, 5°≤β1≤15°, and 5°≤B2≤15°. Of course, the first included angle β1 and the second included angle β2 can be flexibly adjusted according to actual design needs.

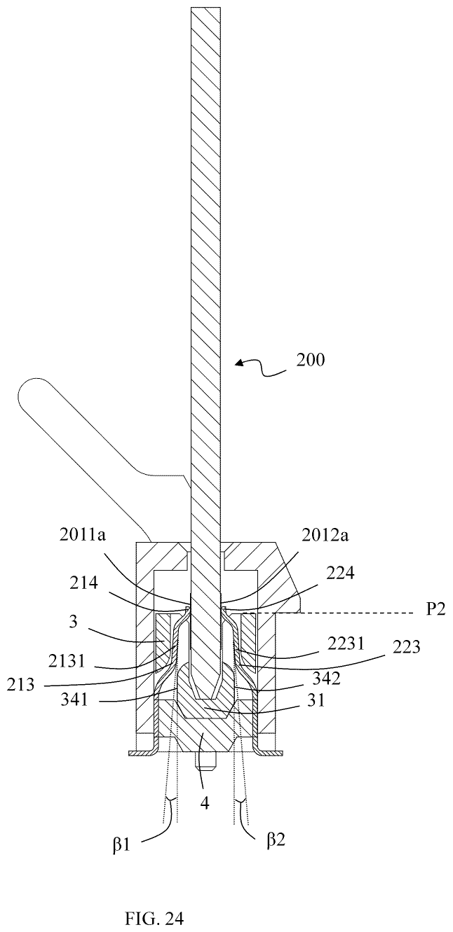

As shown in FIG. 24, the slider 3 includes a first inner wall surface 341 and a second inner wall surface 342. The first inner wall surface 341 and the second inner wall surface 342 are provided on two outer sides of the abutment portion 31. The first elastic arm 213 includes a first extension portion 2131 corresponding to the first inner wall surface 341. The second elastic arm 223 includes a second extension portion 2231 corresponding to the second inner wall surface 342. The first extension portion 2131 is located on an outer side of the first inner wall surface 341. The second extension portion 2231 is located on an outer side of the second inner wall surface 342. When the slider 3 is located at the second position P2, the first extension portion 2131 and the first inner wall surface 341 form a first included angle β1; and the second extension portion 2231 and the second inner wall surface 342 form a second included angle β2. In an embodiment of the present disclosure, 5°≤β1≤15°, and 5°≤β2≤15°. Of course, the first included angle β1 and the second included angle β2 can be flexibly adjusted according to actual design needs.

In the present disclosure, by setting the first included angle β1 and the second included angle β2, when the slider 3 returns from the second position P2 to the first position P1, the friction between the slider 3 and the first extension portion 2131, and the friction between the slider 3 and the second extension portion 2231 can be reduced. It is understandable to those skilled in the art that the first included angle β1 and the second included angle 2 shown in FIG. 23 and FIG. 24 can be applied to other embodiments of the present disclosure, and will not be described again in the present disclosure.

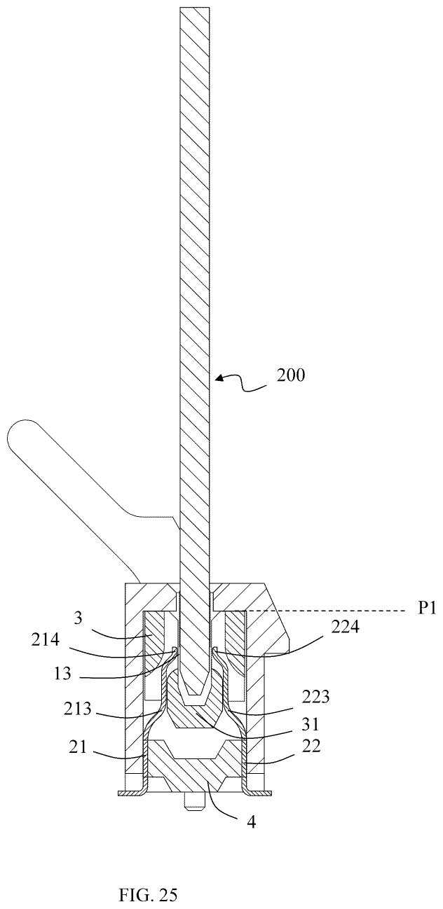

As shown in FIG. 25 to FIG. 27, in a third embodiment of the electrical connector 100 of the present disclosure, the main difference between the electrical connector 100 in the third embodiment and the electrical connector 100 in the second embodiment is deformation manner of the first elastic arm 213 of the first conductive terminal 21 and the second elastic arm 223 of the second conductive terminal 22.

Specifically, as shown in FIG. 25, in the third embodiment of the present disclosure, when the slider 3 is located at the first position P1, the slider 3 does not exert any force on the first conductive terminal 21 and the second conductive terminal 22. The first elastic arm 213 of the first conductive terminal 21 and the second elastic arm 223 of the second conductive terminal 22 are designed according to their own structures, so that the first contact tail 214 of the first conductive terminal 21 and the second contact tail 224 of the second conductive terminal 22 does not protrude into the insertion space 13 in their free states.

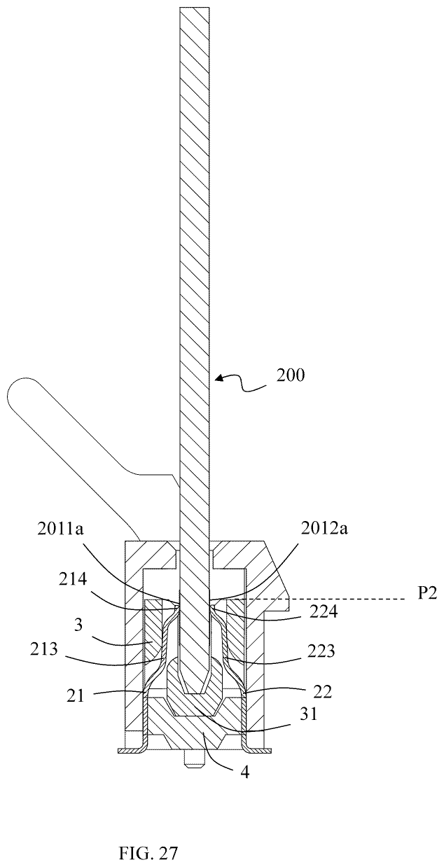

As shown in FIG. 27, when the slider 3 is located at the second position P2, the slider 3 abuts against the first elastic arm 213 of the first conductive terminal 21 and the second elastic arm 223 of the second conductive terminal 22, so that the first elastic arm 213 of the first conductive terminal 21 and the second elastic arm 223 of the second conductive terminal 22 are elastically deformed inwardly, causing the first contact tail 214 of the first conductive terminal 21 and the second contact tail 224 of the second conductive terminal 22 protrude into the insertion space 13.

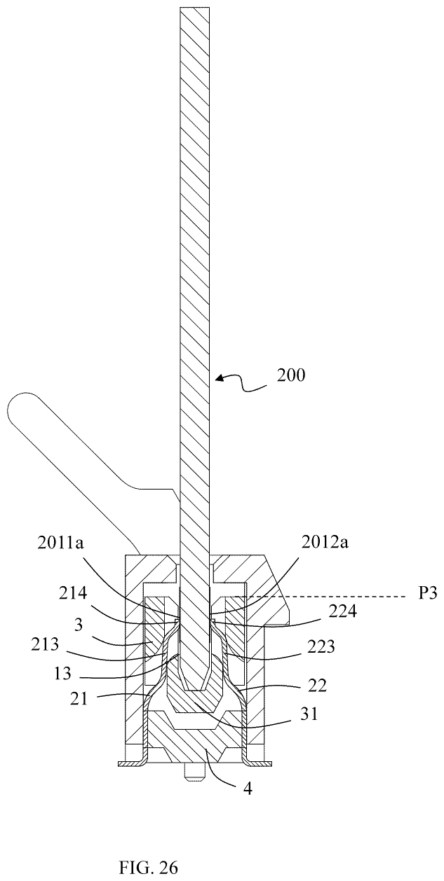

As shown in FIG. 26, the slider 3 also passes through a transition position P3 when moving from the first position P1 to the second position P2. The transition position P3 is located between the first position P1 and the second position P2. When the slider 3 is located at the transition position P3, the first contact tail 214 of the first conductive terminal 21 and the second contact tail 224 of the second conductive terminal 22 protrude into the insertion space 13, and are in contact with the first conductive pad 2011a and the second conductive pad 2012a of the tongue plate 200, respectively.

Referring to FIG. 26 and FIG. 27, when the slider 3 moves from the transition position P3 to the second position P2, the first contact tail 214 of the first conductive terminal 21 and the second contact tail 224 of the second conductive terminal 22 scrap on the first conductive pad 2011a and the second conductive pad 2012a of the tongue plate 200, respectively. This wiping facilitates the removal of impurities (such as dust), thereby improving contact reliability. Of course, it is understandable to those skilled in the art that such wiping should be limited to a certain extent to avoid damage to the first conductive pad 2011a and the second conductive pad 2012a of the tongue plate 200.

Compared with the prior art, the first contact tail 214 of the first conductive terminal 21 of the present disclosure is located at the free end of the first conductive terminal 21. The first contact tail 214 includes the first contact area 2142 configured to contact the first conductive pad 2011a of the tongue plate 200 and the first extending stub 2143 extending from the first contact area 2142 along the centerline direction of the first conductive terminal 21. The second contact tail 224 of the second conductive terminal 22 is located at the free end of the second conductive terminal 22. The second contact tail 224 includes a second contact area 2242 configured to contact the second conductive pad 2012a of the tongue plate 200 and a second extending stub 2243 extending from the second contact area 2242 along the centerline direction of the second conductive terminal 22. The length of the first extending stub 2143 extending along the centerline direction of the first conductive terminal 21 is L1, and the first conductive terminal 21 is configured to transmit the signal with the frequency corresponding to the first wavelength f1, where 0≤L1≤¼*f1. The length of the second extending stub 2243 extending along the centerline direction of the second conductive terminal 22 is L2, and the second conductive terminal 22 is configured to transmit the signal with the frequency corresponding to the second wavelength f2, where 0≤L2≤¼*f2. With this arrangement, the length of the first extending stub 2143 on the first conductive terminal 21 and the length of the second extending stub 2243 on the second conductive terminal 22 of the electrical connector 100 of the present disclosure are relatively short, thereby greatly shortening the useless residual section and improving the performance of the first conductive terminal 21 and the second conductive terminal 22 when transmitting high-speed signals.

Besides, the electrical connector 100 of the present disclosure is provided with the slider 3 which is disposed in the installation space 10 and is configured to move back and forth in the installation space 10 along the insertion and extraction direction. When the slider 3 is located at the first position P1, the first contact tail 214 of the first conductive terminal 21 and the second contact tail 224 of the second conductive terminal 22 do not protrude into the insertion space 13. When the slider 3 is located at the second position P2, the first elastic arm 213 of the first conductive terminal 21 and the second elastic arm 223 of the second conductive terminal 22 move inwardly, causing the first contact tail 214 of the first conductive terminal 21 and the second contact tail 224 of the second conductive terminal 22 protrude into the insertion space 13, and come into contact with the first conductive pad 2011a and the second conductive pad 2012a of the tongue plate 200, respectively. With this arrangement, the slider 3 can protect the first contact tail 214 and the second contact tail 224, thereby reducing the risk of the first contact tail 214 and the second contact tail 224 being damaged.

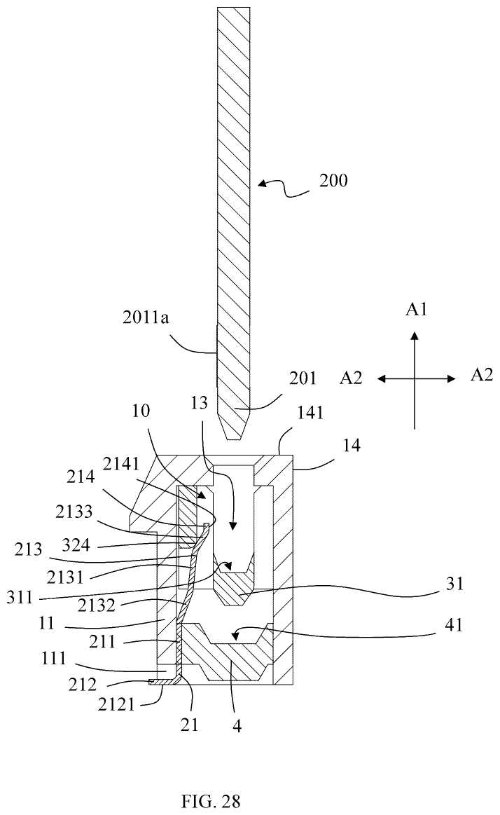

As shown in FIG. 28, in a fourth embodiment of the electrical connector 100 of the present disclosure, the main difference between the electrical connector 100 of the fourth embodiment and the electrical connector 100 in the first embodiment is that only the first conductive terminals 21 are provided and the second conductive terminals 22 are not provided. In other words, the electrical connector 100 in the fourth embodiment of the present disclosure only has one row of conductive terminals located on one side of the insertion space 13. For other structural features and working principles of the electrical connector 100 in the fourth embodiment of the present disclosure, please refer to the description in the first embodiment, and will not be described again in the present disclosure.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector defining an insertion space configured to receive a tongue plate, the electrical connector further comprising:
an installation body, the installation body comprising a first side wall, a second side wall opposite to the first side wall, and an installation space located between the first side wall and the second side wall; the insertion space extending along a first direction;
a plurality of first conductive terminals, the plurality of first conductive terminals being directly or indirectly fixed to the installation body; each first conductive terminal comprising a first elastic arm located on an inner side the first side wall and a first contact tail extending from the first elastic arm; the first contact tail being located at a free end of the first conductive terminal; the first contact tail comprising a first contact area configured to contact a first conductive pad of the tongue plate; a portion of the first contact tail extending from the first contact area along a centerline direction of the first conductive terminal being a first extending stub; and
a slider, the slider being movable in the installation space along an insertion and extraction direction which is parallel to the first direction; the slider comprising an abutment portion located on one side of the plurality of first conductive terminals along a second direction which is perpendicular to the first direction; the abutment portion being configured to be pushed by the tongue plate to move the slider from a first position to a second position;
when the slider is located at the first position, the first contact tail of the first conductive terminal does not protrude into the insertion space;
when the slider is located at the second position, the first contact tail of the first conductive terminal protrudes into the insertion space, the first contact area of the first contact tail is brought into contact with the first conductive pad of the tongue plate;
wherein a length of the first extending stub extending along the centerline direction of the first conductive terminal is L1, and the first conductive terminal is configured to transmit a signal with a frequency corresponding to a first wavelength f1, where 0≤L1≤¼*f1.

2. The electrical connector according to claim 1, wherein 0<L1≤¼*f1; the first extending stub protrudes outwardly beyond the tongue plate and forms a first gap with the tongue plate.

3. The electrical connector according to claim 1, further comprising a resilient element which is configured to exert a restoring force on the slider to return the slider from the second position to the first position, when the tongue plate is pulled out.

4. The electrical connector according to claim 1, wherein the slider passes through a transition position while moving from the first position to the second position; the transition position is located between the first position and the second position;
when the slider is located at the transition position, the first contact tail of the first conductive terminal protrudes into the insertion space, and the first contact area of the first contact tail is in contact with the first conductive pad of the tongue plate.

5. The electrical connector according to claim 4, wherein when the slider moves from the transition position to the second position, the first contact tail of the first conductive terminal wipes on the first conductive pad of the tongue plate.

6. The electrical connector according to claim 1, wherein the first contact tail is provided with a first corner, which is rounded, adjacent to the tongue plate.

7. The electrical connector according to claim 1, wherein the abutment portion defines a positioning groove exposed in the insertion space, and the positioning groove is configured to mate with an insertion portion of the tongue plate.

8. The electrical connector according to claim 1, wherein the slider comprises a first wall portion connected to one side of the abutment portion; the first wall portion is located on an inner side the first side wall; the first wall portion comprises a plurality of first partition ribs and a plurality of first grooves which are spaced apart along a third direction; each first groove is located between two adjacent first partition ribs;
the first elastic arm of the first conductive terminal is located in a corresponding first groove.

9. The electrical connector according to claim 8, wherein each first partition rib comprises a first inner wall surface exposed in the insertion space; the first inner wall surfaces of the plurality of first partition ribs are located in a same plane;
when the slider is located at the first position, the first contact tail does not protrude beyond the first inner wall surfaces;
when the slider is located at the second position, the first contact tail protrudes beyond the first inner wall surfaces to protrude into the insertion space.

10. The electrical connector according to claim 8, wherein the first wall portion defines a plurality of first openings; the first openings and the first grooves are arranged in a one-to-one correspondence manner; the first elastic arm of the first conductive terminal passes through a corresponding first opening to protrude into a corresponding first groove.

11. The electrical connector according to claim 10, wherein the first wall portion is provided with a first force applying portion;
when the slider is located at the second position, the first force applying portion abuts against the first elastic arm of the first conductive terminal, so that the first contact tail of the first conductive terminal is protruded into the insertion space to be in contact with the first conductive pad of the tongue plate.

12. The electrical connector according to claim 11, wherein the first force applying portion is a first corner of the first wall portion exposed in the corresponding first opening, and the first corner is arc-shaped.

13. The electrical connector according to claim 1, wherein the installation body comprises a mating portion; the first side wall is connected to one side of the mating portion; the second side wall is connected to another side of the mating portion; the mating portion comprises a mating surface through which the insertion space extends along the first direction; the mating portion is configured to abut against the slider so as to limit a position of the slider.

14. The electrical connector according to claim 1, wherein when the slider is located at the first position, the slider abuts against the first elastic arm of the first conductive terminal outwardly, so that the first contact tail of the first conductive terminal does not protrude into the insertion space;
when the slider is located at the second position, an abutting force on the first elastic arm of the first conductive terminal is reduced; the first elastic arm of the first conductive terminal moves inwardly, causing the first contact tail of the first conductive terminal to protrude into the insertion space.

15. The electrical connector according to claim 1, wherein the slider is provided with a first inner wall surface, and the first elastic arm is provided with a first extension portion corresponding to the first inner wall surface;
when the slider is located at the second position, the first extension portion and the first inner wall surface form a first included angle; the first included angle is configured to reduce friction between the slider and the first extension portion when the slider returns from the second position to the first position.

16. The electrical connector according to claim 1, wherein when the slider is located at the first position, the slider exerts no force on the first conductive terminal, and the first contact tail of the first conductive terminal does not protrude into the insertion space;
when the slider is located at the second position, the slider abuts against the first elastic arm of the first conductive terminal, so that the first elastic arm of the first conductive terminal is elastically deformed inwardly, thereby causing the first contact tail of the first conductive terminal to protrude into the insertion space.

17. The electrical connector according to claim 1, further comprising a plurality of second conductive terminals; the plurality of second conductive terminals being directly or indirectly fixed to the installation body; each second conductive terminal comprising a second elastic arm located on an inner side of the second side wall and a second contact tail extending from the second elastic arm; the second contact tail being located at a free end of the second conductive terminal; the second contact tail comprising a second contact area configured to contact a second conductive pad of the tongue plate; a portion of the second contact tail extending from the second contact area along a centerline direction of the second conductive terminal being a second extending stub; wherein a length of the second extending stub extending along the centerline direction of the second conductive terminal is L2; and the second conductive terminal is configured to transmit a signal with a frequency corresponding to a second wavelength f2, where 0≤L2≤¼*f2.

18. The electrical connector according to claim 17, wherein when the slider is located at the first position, the second contact tail of the second conductive terminal does not protrude into the insertion space;
when the slider is located at the second position, the second contact tail of the second conductive terminal protrudes into the insertion space, so that the second contact area of the second contact tail is brought into contact with the second conductive pad of the tongue plate.

19. The electrical connector according to claim 17, further comprising an insulating block fixed to the plurality of first conductive terminals and fixed to the plurality of second conductive terminals;
wherein each first conductive terminal comprises a first fixing portion fixed to the insulating block and a first mounting portion extending from the first fixing portion; the first elastic arm of each first conductive terminal comprises a first extension portion, a first connecting portion connecting the first extension portion and the first fixing portion, and a second connecting portion connecting the first extension portion and the first contact tail; the first fixing portion, the first connecting portion, the first extension portion, the second connecting portion and the first contact tail approach the insertion space in sequence along the second direction and are arranged in sequence along the first direction;
wherein each second conductive terminal comprises a second fixing portion fixed to the insulating block and a second mounting portion extending from the second fixing portion; the second elastic arm of each second conductive terminal comprises a second extension portion, a third connecting portion connecting the second extension portion and the second fixing portion, and a fourth connecting portion connecting the second extension portion and the second contact tail; the second fixing portion, the third connecting portion, the second extension portion, the fourth connecting portion and the second contact tail approach the insertion space in sequence along the second direction and are arranged in sequence along the first direction.

20. The electrical connector according to claim 19, wherein the first extension portion extends obliquely and is configured to be abutted against by the slider when the slider is located at the second position;
the second extension portion extends obliquely and is configured to be abutted against by the slider when the slider is located at the second position.
